(19) United States
(12) Patent Application Publication
(10) Pub. No.: US 2013/0161042 A1
(43) Pub. Date: Jun. 27, 2013

(54) HAND-HELD TOOL DEVICE

(71) Applicants: Jens BLUM, Filderstadt (DE); Heiko ROEHM, Stuttgart (DE); Tobias HERR, Stuttgart (DE)

(72) Inventors: Jens BLUM, Filderstadt (DE); Heiko ROEHM, Stuttgart (DE); Tobias HERR, Stuttgart (DE)

(21) Appl. No.: 13/726,942

(22) Filed: Dec. 26, 2012

(30) Foreign Application Priority Data
Dec. 27, 2011 (DE) 10 2011 089 919.7

(51) Int. Cl. B23Q 5/12

(52) U.S. Cl. CPC B23Q 5/12
USPC 173/48

(57) ABSTRACT

A hand-held tool device having at least one operating device via which the at least one first transmission ratio and one second transmission ratio and a percussion drilling mode are able to be set. The hand-held tool device has a protective device which prevents an operation in the first transmission ratio in the percussion drilling mode.

### CROSS REFERENCE

The present application claims the benefit under 35 U.S.C. §119 of German Patent Application No. DE 102011089919.7 filed on Dec. 27, 2011, which is expressly incorporated herein by reference in its entirety.

### FIELD

The present invention relates to a hand-held tool device having at least one operating device via which the at least one first transmission ratio and a second transmission ratio and a percussion drilling mode are able to be set.

### SUMMARY

An example hand-held tool device in accordance with the present invention includes a protective device, which prevents the operation in the first transmission ratio in the percussion drilling mode. By an “operating device” one should understand, in this connection, particularly a device via which an operator is able to set an operating mode, at least of a striking mechanism of the hand-held tool device, and a transmission ratio particularly of a planetary transmission of the hand-held tool device. The operating device is preferably provided to show to the operator the currently set operating state, namely, advantageously by a device of at least one operating element of the operating device. “Provided” is to be understood in particular as specially designed and/or equipped. By “protective device” one should understand a device which protects the operator during a working procedure.

The protective device is preferably provided to protect the operator, especially in a blocking case of the percussion drilling mode, by the limitation of the maximum tool torque. By a “tool torque” one should particularly understand a torque brought about by the tool chuck particularly on an insertable tool. By a “maximum tool torque” one should understand particularly a tool torque that occurs in an operating mode in response to a soft blocking case. The maximum tool torque should be determined according to the standard DIN EN 60745. In a soft blocking case, the tool chuck is braked by the insertable tool slowly and uniformly, particularly within two revolutions of the tool chuck. By “transmission ratio” one should understand particularly an operating mode which is associated with a ratio of a rotational speed of a rotor of a drive unit of the hand-held tool device and a tool chuck of the hand-held tool device. The first transmission ratio preferably has a small maximum rotational speed and a large maximum tool torque, that is, particularly a tool torque greater than 15 Nm. The second transmission ratio preferably includes a large maximum rotational speed and a small maximum tool torque, that is, particularly a tool torque less than 15 Nm. By “percussion drilling mode” one should particularly understand an operating mode of the hand-held tool device in which the tool chuck and particularly a striking mechanism of the hand-held tool device drive the insertable tool in a rotating and striking manner. By the term “able to be set” one should particularly understand that the operator, using the operating device, is able to put the hand-held tool device at least into the first transmission ratio, into the second transmission ratio and/or into the percussion drilling mode. In addition, preferably one is able to set at least a screw mode and a drilling mode via the operating device. Furthermore, an additional transmission ratio and a chisel mode could be able to be set via the operating device. By a “screw mode” one should particularly understand an operating mode of the hand-held tool device, in which the tool chuck rotationally drives the insertable tool up to a maximum tool torque that is able to be set, namely, without a striking motion, in particular. By a “drilling mode” one should particularly understand an operating mode of the hand-held tool device, in which the tool chuck rotationally drives the insertable tool up to a maximum tool torque that is able to be set, namely, without a striking motion, in particular. By a “chisel mode” one should particularly understand an operating mode of the hand-held tool device in which the insertable tool is driven only in a striking manner. By “operation in the first transmission ratio” one should particularly understand an operating state in which the first transmission ratio is set. By the term “prevent” one should particularly understand, in this connection, that the protective device excludes the simultaneous operation in the first transmission ratio and in the percussion drilling mode. Because of the embodiment of the hand-held tool device according to the present invention, an especially safe percussion drilling operation is made possible in a constructively simple manner.

Moreover, it is provided that the protective device prevents switching over into the percussion drilling mode when the first transmission ratio is set, whereby a particularly simple, cost-effective and reliable construction is made possible. The protective device advantageously prevents the engaging of the operating element in a position assigned to the percussion drilling mode, when the first transmission ratio is set. The protective device particularly advantageously prevents the displacing of the operating element into a position assigned to the percussion drilling mode, when the first transmission ratio is set. Alternatively, the protective device could prevent an operation when the percussion drilling mode and the first transmission ratio are set at the same time, for example, by opening a mechanical clutch or particularly by the electrical switching off of the drive unit.

Moreover, it is provided that the protective device prevents switching over into the first transmission ratio when the percussion drilling mode is set, whereby a particularly simple, cost-effective and reliable construction is attainable. The protective device advantageously prevents the engaging of the operating element in a position assigned to the second transmission ratio, when the percussion drilling mode is set. The protective device particularly advantageously prevents the displacing of the operating element into a position assigned to the first transmission ratio, when the percussion drilling mode is set.

Furthermore, it is provided that a maximum tool torque in the first transmission ratio amount to more than 15 Nm, whereby, in the drilling mode and the screw mode, a particularly effective operation is made possible.

In addition, it is provided that a maximum tool torque in the second transmission ratio amount to less than 15 Nm, whereby, in the drilling mode, an advantageously high rotational speed and in the percussion drilling mode a particularly safe operation is attainable.

Furthermore, the operating device may have a first operating element, via which the first transmission ratio and the second transmission ratio are able to be set, whereby a particularly operator-friendly selection of the transmission ratios is made possible in a constructively simple manner. By an “operating element” one should particularly understand a component which outputs a characteristic variable that is a function of an operator input, particularly an electric one and/or advantageously a mechanical one. The operating element is preferably developed as an operating element that appears meaningful to one skilled in the art, particularly advantageously as a mechanically acting switch.

In one advantageous development of the present invention, it is provided that the operating device have a second operating element, via which at least the percussion drilling mode is able to be set, whereby, in a constructively simple manner, the transfer of the setting is able to be made from the operating elements to a planetary transmission and a striking mechanism of the hand-held tool device.

Moreover, it is provided that the protective device be developed at least partially as one piece with the operating device, whereby a particularly safe operation is made possible using an advantageously simple construction. By “at least partially as one piece” one should particularly understand in one continuous material, such as by a welding process and/or an adhesion process, etc., and particularly advantageously connected in an attached form, such as by production by casting and/or production in a monocomponent or multicomponent injection molding method.

In addition, the hand-held tool device may include a torque limitation unit that is able to be set, which is provided for limiting a maximum tool torque in a screw mode, whereby a particularly convenient operation in the screw mode is attainable. The torque limitation unit and the protective device are preferably developed separately from each other. By “torque limitation unit” one should particularly understand a unit provided to limit a maximum tool torque acting on a workpiece, especially on a screw. By “able to be set” one should particularly understand, in this connection, that a maximum tool torque is able to be selected by an operator in at least three stages, advantageously at least five stages.

Furthermore, the operating device may be provided to deactivate the torque limitation unit in a drilling mode, whereby advantageously high tool torques are able to be supplied for a drilling operation, particularly for drill bits having a large diameter. By “deactivate” one should understand, in this connection, that the operating device prevents the action of the torque limitation unit in the drilling mode, whereby a maximum tool torque is a function of the torque of the drive unit and the selected transmission ratio.

In addition, the present invention relates to an hand-held tool having an hand-held tool device according to the present invention. The hand-held tool is preferably provided to actuate the insertable tool in a screw mode, in a drilling mode, in a screw drilling mode and particularly in a chisel mode.

### BRIEF DESCRIPTION OF THE DRAWINGS

Further advantages are derived from the description below of the figures. The figures show five exemplary embodiments of the present invention. The figures and the description contain numerous features in combination. One skilled in the art will expediently also consider the features individually, and will combine them into useful further combinations.

FIG. 1 shows a section of an hand-held tool having an example hand-held tool device according to the present invention.

FIG. 2 shows a partially left open section through a striking mechanism and a planetary transmission of the hand- held tool device of FIG. 1.

FIG. 3 shows a first sectional area A of the striking mechanism of the hand-held tool device of FIG. 1.

FIG. 4 shows a second sectional area B of the striking mechanism of the hand-held tool device of FIG. 1.

FIG. 5 shows a perspective representation of a striking mechanism spindle of the striking mechanism of the hand-held tool device of FIG. 1.

FIG. 6 shows a perspective representation of a beater of the striking mechanism of the hand-held tool device of FIG. 1.

FIG. 7 shows a sectional area C of a first planetary transmission stage and a first striking mechanism shut-off device of the hand-held tool device of FIG. 1.

FIG. 8 shows a sectional area D of a control element and a second striking mechanism shut-off device of the hand-held tool device of FIG. 1.

FIG. 9 shows a perspective sectional representation of a part of the hand-held tool device of FIG. 1.

FIG. 10 shows a sectional area E of a spindle blocking device of the hand-held tool device of FIG. 1.

FIG. 11 shows a sectional area F through a blocking arrangement of a spindle blocking device of the hand-held tool device of FIG. 1.

FIG. 12 shows a sectional area G of a second planetary transmission stage of the hand-held tool device of FIG. 1.

FIG. 13 shows a sectional area H of a third planetary transmission stage of the hand-held tool device of FIG. 1.

FIG. 14 shows a sectional area I of a fourth planetary transmission stage of the hand-held tool device of FIG. 1.

FIG. 15 shows a schematic representation of an operating device and a protective device of the hand-held tool device of FIG. 1.

FIG. 16 shows an alternative exemplary embodiment of a first striking mechanism shut-off device of a hand-held tool device according to the present invention.

FIG. 17 shows an additional exemplary embodiment of a first striking mechanism shut-off device of an hand-held tool device according to the present invention,

FIG. 18 shows an alternative exemplary embodiment of a striking mechanism switch spring of an hand-held tool device according to the present invention.

FIG. 19 shows an alternative exemplary embodiment of an operating device and a protective device of an hand-held tool device according to the present invention.

### DETAILED DESCRIPTION OF EXAMPLE EMBODIMENTS

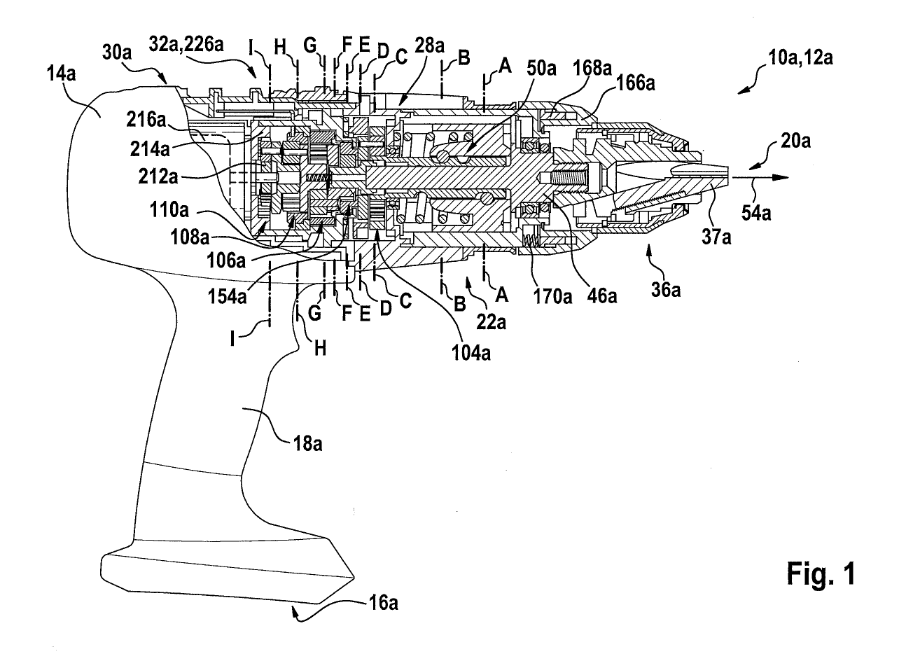

FIG. 1 shows an example hand-held tool 10a. Hand-held tool 10a is a percussion drilling screw machine. Hand-held tool 10a has an hand-held tool device 12a according to the present invention, an hand-held tool housing 14a and a battery interface 16a. Battery interface 16a is provided to supply hand-held tool device 12a with electric power from a hand-held tool battery not shown here in greater detail. Hand-held tool housing 14a is developed in the shape of a pistol. Hand-held tool housing 14a is developed to have many parts. It includes an hand grip 18a, by which an operator holds hand-held tool 10a during a working process. Hand-held tool device 12a includes a tool guide unit 20a, a striking mechanism 22a, a first striking mechanism shut-off device 24a, a second striking mechanism shut-off device 26a, a planetary transmission 28a, a drive unit 30a, an operating device 32a and a torque limitation unit 34a.

Tool guide unit 20a includes a tool chuck 36a and a tool spindle 38a. During a working process, tool chuck 36a fastens an insertable tool not shown here, such as a drill or a screw bit. Tool chuck 36a fastens the insertable tool in a force-locking manner. Tool chuck 36a has three clamping jaws that an operator is able to fasten movably, which fasten the insertable tool during a working process. In addition, tool chuck 36a fastens the insertable tool during a working process in a manner that is axially immovable with respect to tool chuck 36a and particularly with respect to tool spindle 38a. One part of tool chuck 36a and tool spindle 38a are connected to each other relatively immovably. In this case, tool chuck 36a and tool spindle 38a are screwed together. Hand-held tool device 12a has a bearing device 40a, which supports tool spindle 38a on a side facing tool chuck 36a. Bearing device 40a supports tool spindle 38a in an axially displaceable manner. Bearing device 40a is connected axially fixed to tool spindle 38a. Bearing device 40a is supported axially movable to hand-held tool housing 14a. Hand-held tool device 12a has an additional bearing device 41a, which supports tool spindle 38a on a side facing planetary transmission 28a. In this embodiment, bearing device 41a is a roller bearing, in this case as a needle bearing, whereby a support having little play is made possible. Bearing device 41a supports tool spindle 38a in an axially displaceable manner. A striking mechanism spindle 46a encloses bearing device 41a. Bearing device 41a is functionally situated between tool spindle 38a and striking mechanism spindle 46a.

Tool spindle 38a includes a striking surface 42a, which a beater 44a of the striking mechanism 22a beats during a percussion drilling operation. Beater 44a has a mass that is maximally two-thirds the size of the mass of tool guide unit 20a. In this case, the mass of beater 44a is less than one-half as great as the mass of tool guide unit 20a. The mass of beater 44a amounts to about 45% of the mass of tool guide unit 20a.

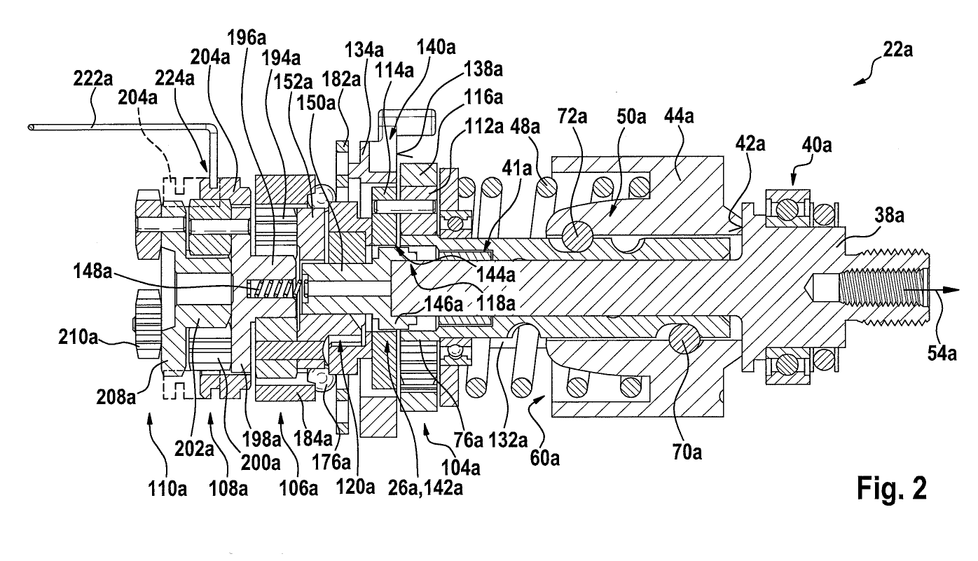

In FIG. 2, striking mechanism 22a and planetary transmission 28a are shown in greater detail. Striking mechanism 22a has beater 44a, striking mechanism spindle 46a, a striking mechanism spring 48a, a striking mechanism driving device 50a and a beater guide 52a. Beater 44a is supported translatorially movable in striking direction 54a. Striking direction 54a is aligned parallel to an axial direction of striking mechanism spindle 46a.

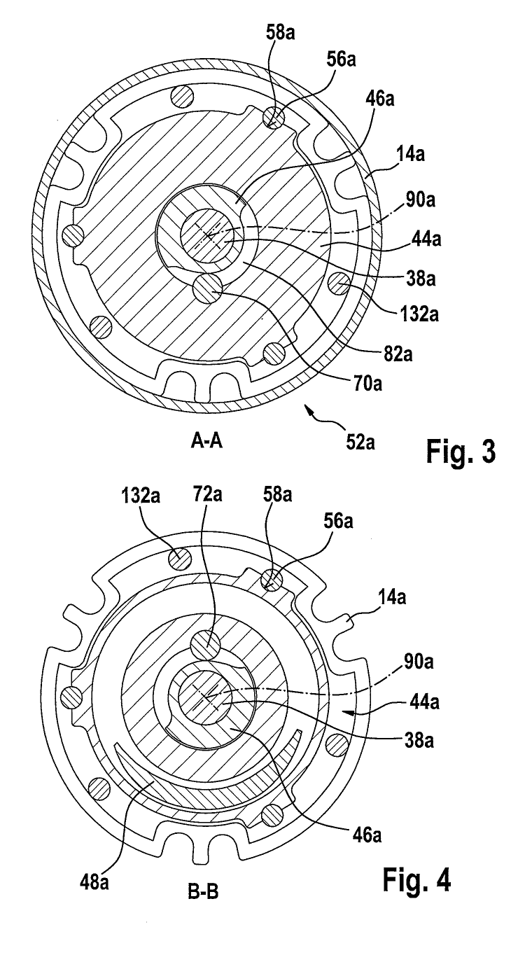

FIGS. 3 and 4 show a sectional area A and a sectional area B of striking mechanism 22a. Beater guide 52a supports beater 44a torsionally fixed with respect to hand-held tool housing 14a. Beater guide 52a has three guide rods 56a on which beater 44a slides. Guide rods 56a are situated regularly around beater 44a. Beater 44a has sliding surfaces 58a, which enclose guide rods 56a in a plane perpendicular to striking direction 54a over 180 degrees. Beater 44a encloses striking mechanism spindle 46a in a plane aligned perpendicular to striking direction 54a, over 360 degrees. In addition, beater 44a encloses tool spindle 38a on the plane over 360 degrees. Moreover, striking mechanism spindle 46a encloses on the plane tool spindle 38a over 360 degrees. Striking mechanism spindle 46a is situated coaxially with tool spindle 38a.

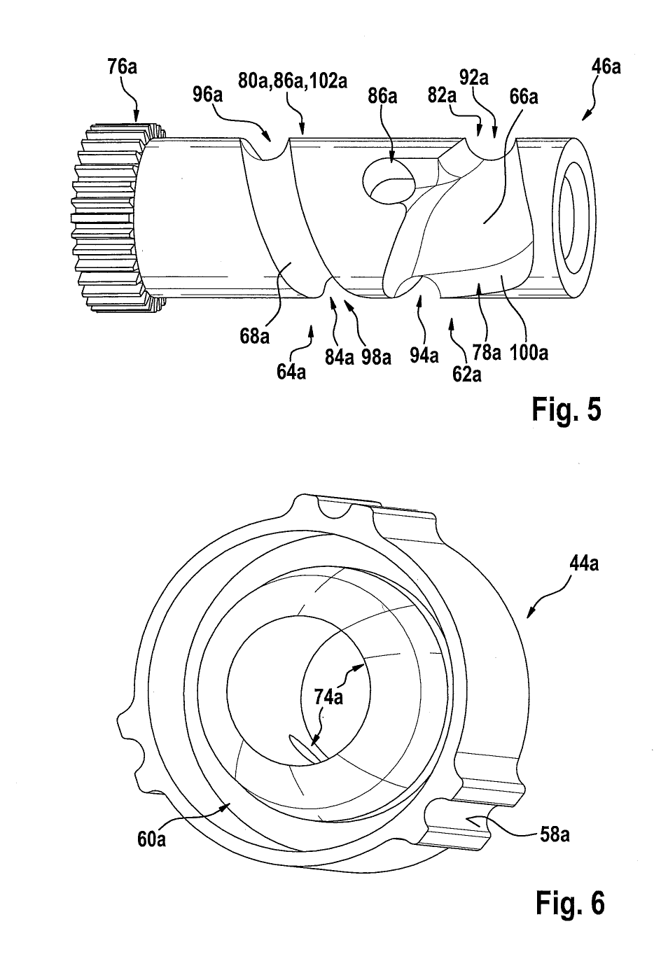

Striking mechanism spring 48a accelerates beater 44a before a strike in striking direction 54a. For this purpose, hand-held tool housing 14a supports striking mechanism spring 48a on a side facing away from beater 44a. Striking mechanism spring 48a presses directly against beater 44a. Beater 44a has a spring fastening 60a. Spring fastening 60a is developed as an annular depression. FIG. 5 shows striking mechanism spindle 46a in a perspective view. FIG. 6 shows beater 44a in a perspective view. Beater driving device 50a has a first curve guide 62a and a second first curve guide 64a. Curve guides 62a, 64a each include a guiding curve 66a, 68a and connecting means 70a, 72a. Connectors 70a, 72a are developed to be ball-shaped. Beater 44a supports connectors 70a, 72a in place with respect to beater 44a. Beater 44a has hemisphere-shaped fastening recesses 74a. Connectors 70a, 72a slide in guiding curves 66a, 68a during a percussion drilling operation. Striking mechanism spindle 46a has a part of curve guides 62a, 64a, namely, guiding curve 66a, 68a. Striking mechanism spindle 46a borders a space in which connecting means 70a, 72a move during a percussion drilling operation.

In this embodiment, striking mechanism spindle 46a is a hollow shaft. Planetary transmission 28a drives striking mechanism spindle 46a. For this purpose, striking mechanism spindle 46a has a toothing 76a on the side facing away from tool chuck 36a. Guiding curves 66a, 68a each have an impact-free regions 78a, 80a, an impact winding region 82a, 84a and an assembly recess 86a, 88a. During assembly, connectors 70a, 72a are inserted through assembly recesses 86a, 88a into fastening recesses 74a of beater 44a. In a percussion drilling operation, striking mechanism spindle 46a rotates clockwise as seen in striking direction 54a. Impact winding regions 82a, 84a are developed to be spiral-shaped. They extend over 180 degrees about a rotational axis 90a of striking mechanism spindle 46a. Impact winding regions 82a, 84a move connectors 70a, 72a, and with that, beater 44a counter to striking direction 54a in the percussion drilling operation. Consequently, striking mechanism 22a has connectors 70a, 72a which, in at least one operating state, transfer a motion from striking mechanism spindle 46a to beater 44a.

Impact-free regions 78a, 80a each connect two ends 92a, 94a, 96a, 98a of impact winding regions 82a, 84a. Impact-free regions 78a, 80a extend over 180 degrees about a rotational axis 90a of striking mechanism spindle 46a. Impact-free regions 78a, 80a each have an impact side 100a, 102a which, starting from an end 94a, 96a of impact winding region 82a, facing planetary transmission 28a, runs approximately parallel to striking direction 54a. After the connectors 70a, 72a penetrate impact-free regions 78a, 80a, striking mechanism spring 48a accelerates beater 44a and connecting means 70a, 72a in striking direction 54a. In this context, connecting means 70a, 72a move through impact free-wheeling regions 78a, 80a, without experiencing an axial force, until beater 44a hits striking surface 42a. Curve guides 62a, 64a are situated about rotational axis 90a, offset by 180 degrees. Curve guides 62a, 64a are situated one behind the other in the axial direction.

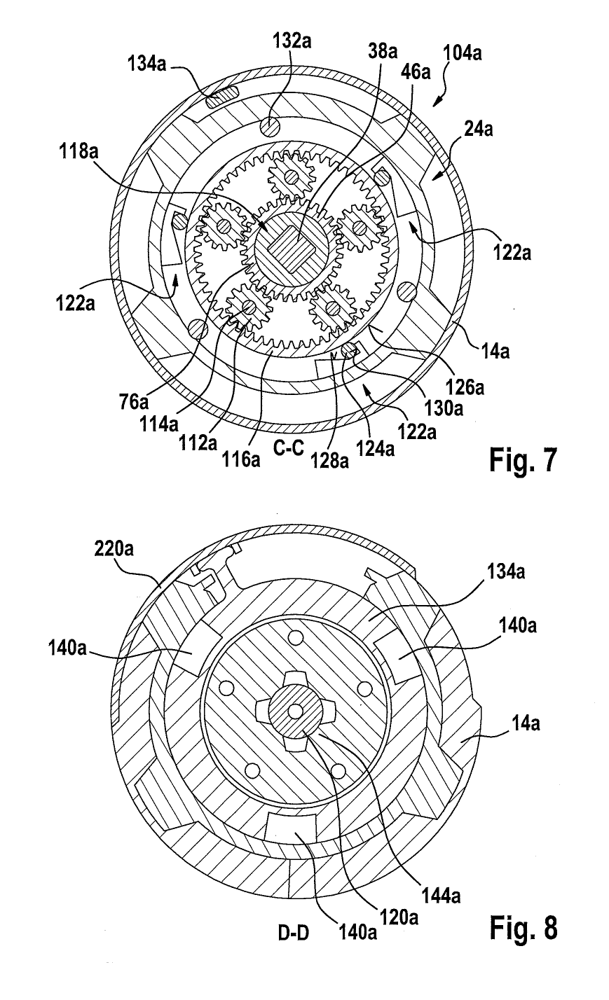

Planetary transmission 28a has first planetary transmission stage 104a, a second planetary transmission stage 106a, a third planetary transmission stage 108a and a fourth planetary transmission stage 110a FIG. 7 shows a sectional area C of first planetary transmission stage 104a. Planetary transmission stages 104a, 106a, 108a, 110a shown in FIGS. 7, 12, 13 and 15 have toothed wheels having a number of teeth as needed. The toothed wheels of planetary transmission stages 104a, 106a, 108a, 110a engage with one another, which, in this case, is partially not shown like that. First planetary transmission stage 104a increases a first rotational speed of second planetary transmission stage 106a for driving striking mechanism 22a. Second planetary transmission stage 106a drives tool spindle 38a at this first rotational speed. Toothing 76a of striking mechanism spindle 46a forms a sunwheel of first planetary transmission stage 104a. Toothing 76a meshes with planet pinions 112a of first planetary transmission stage 104a, which are guided by a planet carrier 114a of first planetary transmission stage 104a. An internal geared wheel 116a of first planetary transmission stage 104a meshes with planet pinions 112a of first planetary transmission stage 104a.

During a percussion drilling operation, first striking mechanism shut-off device 24a fixes internal geared wheel 116a of first planetary transmission stage 104a immovable with respect to hand-held tool housing 14a. First striking mechanism shut-off device 24a is provided to switch on beater driving device 50a in response to a first right-hand drilling rotation direction, and to switch off automatically beater driving device 50a in response to a second, left-hand drilling rotation direction. First striking mechanism shut-off device 24a acts on internal geared wheel 116a of first planetary transmission stage 104a. First striking mechanism shut-off device 24a blocks internal geared wheel 116a of first planetary transmission stage 104a at the first right-hand drilling rotation direction. First striking mechanism shut-off device 24a releases internal geared wheel 116a of first planetary transmission stage 104a in response to second, left-hand drilling rotation direction, so that it is able to rotate. For this purpose, striking mechanism shut-off device 24a has three clamping mechanisms 122a. Clamping mechanisms 122a each include a blocking arrangement 124a, a first clamping surface 126a, a second clamping surface 128a and free-wheeling surfaces 130a. Seal 124a is developed as a roller. First clamping surface 126a forms an area, lying outside, of a surface of internal geared wheel 116a of first planetary transmission stage 104a. Second clamping surface 128a is situated immovable with respect to hand-held tool housing 14a. During an operation in the first, right-hand drilling rotation direction, blocking arrangement 124a clamp between first clamping surfaces 126a and second clamping surface 128a. During an operation in the second, left-hand drilling rotation direction, free-wheeling areas 130a guide blocking arrangement 124a and prevent clamping.

Furthermore, FIG. 7 shows connector 118a, which connects tool spindle 38a and a planet carrier 120a of the second planetary transmission stage 106a in a torsionally fixed manner. Connecting means 118a connects tool spindle 38a and planet carrier 120a of second planetary transmission stage 106a in an axially displaceable manner, in this case.

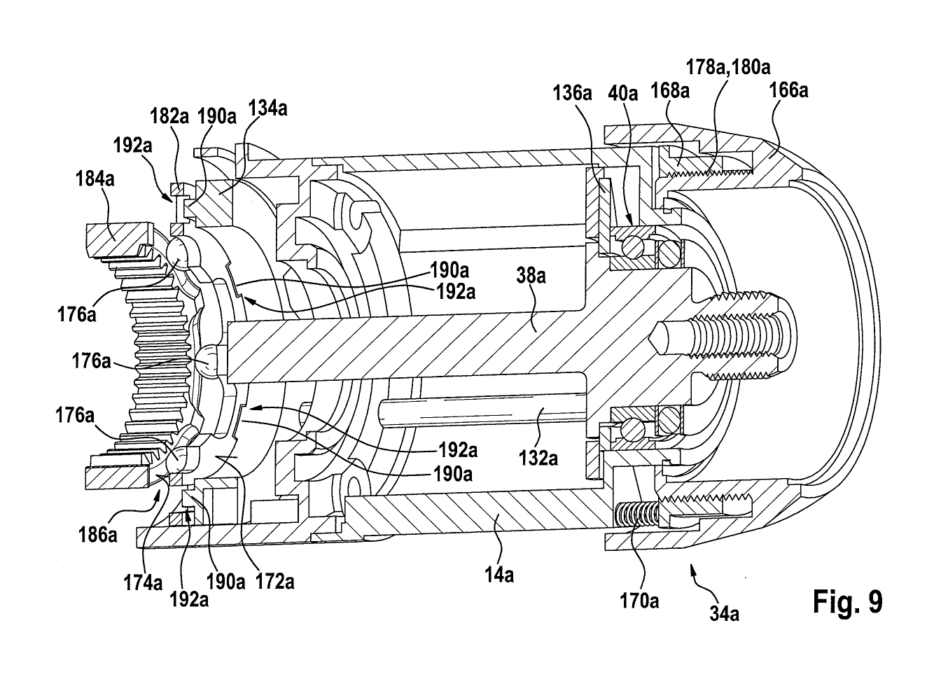

Moreover, FIGS. 3, 4 and 7 show three first transfer devices 132a of second striking mechanism shut-off device 26a. In this embodiment, transfer devices 132a are implemented as rods. FIG. 8 shows a sectional area D through a control element 134a of hand-held tool device 12a. FIG. 9 shows second striking mechanism shut-off device 26a in a perspective sectional representation. Control element 134a supports tool guide unit 20a in a screw mode shown in FIGS. 1, 8 and 9 and in a drilling mode in a direction counter to striking direction 54a. A force applied to tool guide unit 20a acts via bearing device 40a, a second transfer device 136a of second striking mechanism shut-off device 26a and first transfer device 132a on support areas 138a of control element 134a. Control element 134a has three recesses 140a. In a percussion drilling operation shown in FIG. 2, first transfer device 132a is able to be inserted into recesses 140a, whereby tool guide unit 20a is axially movable.

Second striking mechanism shut-off device 26a has a striking mechanism shut-off clutch 142a. Striking mechanism shut-off clutch 142a is partially developed as one piece with planetary transmission 28a. Striking mechanism shut-off clutch 142a is situated between first planetary transmission stage 104a and second planetary transmission stage 106a. Striking mechanism shut-off clutch 142a has a first clutch 144a which is connected torsionally fixed to a planet carrier 114a of first planetary transmission stage 104a. Striking mechanism shut-off clutch 142a has a second clutch element 146a which is connected torsionally fixed to a planet carrier 120a of first planetary transmission stage 106a. In the screw mode and the drilling mode shown, striking mechanism shut-off clutch 142a is opened. In a percussion drilling operation, tool spindle 38a transfers an axial clutching force to striking mechanism shut-off clutch 142a when the operator presses an insertable tool against a workpiece. The clutching force closes striking mechanism shut-off clutch 142a. In FIG. 2, striking mechanism shut-off clutch 142a is shown closed. When the operator of the insertable tool removes it from the workpiece, a striking mechanism switching spring 148a of hand-held tool device 12a opens striking mechanism shut-off clutch 142a.

Planet carrier 120a of second planetary transmission stage 106a is developed as two parts. A first part 150a of planet carrier 120a of second planetary transmission stage 106a is connected torsionally fixed to tool spindle 38a. First part 150a of planet carrier 120a is connected to tool spindle 38a in an axially displaceable manner, whereby planet carrier 120a remains torsionally coupled to tool spindle 38a even during a striking maneuver. Thus, first part 150a is permanently connected to tool spindle 38a. First part 150a of planet carrier 120a is supported dispaceably against striking mechanism switching spring 148a. A second part 152a of planet carrier 120a of second planetary transmission stage 106a is connected torsionally fixed to first part 150a of planet carrier 120a. First part 150a and second part 152a of planet carrier 120a are connected to each other in an axially displaceable manner. First part 150a and second part 152a of planet carrier 120a are connected permanently in a torsionally fixed manner.

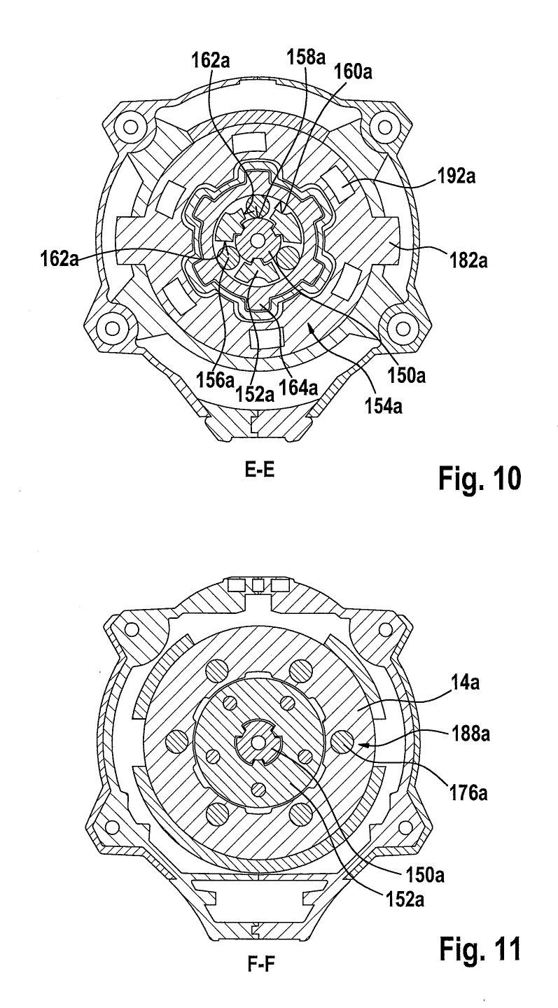

FIG. 10 shows a sectional area of a spindle blocking device 154a of hand-held tool device 12a. Spindle blocking device 154a is provided to connect tool spindle 38a to hand-held tool housing 14a in a torsionally fixed manner, when a tool torque is applied to tool chuck 36a, for instance, during the clamping of an insertable tool into tool chuck 36a. Spindle blocking device 154a is partially developed as one piece with planet carrier 120a of second planetary transmission stage 106a. Spindle blocking device 154a has blocking device 156a, first clamping surfaces 158a, a second clamping surface 160a and free-wheeling surfaces 162a. Blocking device 156a is developed in a roller-shaped manner. First clamping surfaces 158a are developed as areas of a surface of first part 150a of planet carrier 120a of second planetary transmission stage 106a. In this embodiment, first clamping surfaces 158a is flat. Second clamping surface 164a is developed as the inner side of a clamping ring 164a of spindle blocking device 154a. Clamping ring 164a is connected torsionally fixed to hand-held tool housing 14a. Free-wheeling surfaces 162a are developed as areas of a surface of first part 152a of planet carrier 120a of second planetary transmission stage 106a. When a tool torque is applied to tool chuck 36a, blocking device 156a clamps between first clamping surfaces 158a and second clamping surface 160a. When drive unit 30a is driving, free-wheeling surfaces 162a guide blocking device 156a on a circular path and prevent clamping. First part 150a and second part 152a of planet carrier 120a are geared to each other, having play.

FIGS. 1, 2, 9 and 10 shows torque limitation unit 34a. Torque limitation unit 34a is provided to limit the tool torque that is maximally output by tool chuck 36a in a screw mode. Torque limitation unit 34a includes an operating unit 166a, an adjusting element 168a, limitation strings 170a, transfer devices not shown in greater detail, first impact surfaces 172a, a second impact surface 174a and limitation means 176a. Operating element 166a is developed to be ring-shaped. It follows tool chuck 36a, in the direction of planetary transmission 28a. Operating element 166a has a setting screw thread 178a, which is matched to a setting screw thread 180a of adjusting element 168a. Adjusting element 168a is supported torsionally fixed and axially displaceable. A rotation of operating element 166a displaces adjusting element 168a in the axial direction. Limiting springs 170a are supported on one side on adjusting element 168a. Limiting springs 170a are supported on another side via the transfer arrangement to impact device 182a of torque limitation unit 34a. A surface of impact device 182a has first impact surface 172a. In screw mode, impact device 182a is displaceably supported in the axial direction by limiting springs 170a. Second impact surface 174a is developed as an area of the surface of an internal geared wheel 184a of second planetary transmission stage 106a. Second striking surface 174a has trough-shaped depressions 186a. Limiting device 176a is developed in a ball-shaped manner. Limiting device 176a is supported displaceably in tube-shaped recesses 188a in impact direction 54a. FIG. 11 shows a sectional area F of torque limitation unit 34a. During a screw process, limitation devices 176a are situated in the trough-shaped recessions 186a. Limitation devices 176a fasten internal geared wheel 184a of second planetary transmission stage 106a. When the maximum tool torque, that is set, has been reached, limitation devices 176a press away impact device 182a against limiting springs 170a. Then, limitation devices 176a each jump in the next one of the trough-shaped depressions 186a. In the process, internal geared wheel 194a of second planetary transmission stage 106a is turning, whereby the screw process is interrupted.

Control element 134a of hand-held tool device 12a has supporting device 190a, which, at least during a drilling operation, prevents an axial motion of impact device 182a. For this purpose, supporting device 190a support impact device 182a in the axial direction. Impact device 182a has screw recesses 192a, into which impact device 182a dip in response to reaching the maximum tool torque, particularly in a screw operation as shown in FIG. 9. Supporting device 190a are situated accordingly during a screw setting of control element 134a. In the case of a percussion drilling operation, support devices 190a each also prevent an axial motion of impact means 182a and, with that, a response of torque limitation unit 34a. As an alternative, impact devices could also be situated, during a percussion drilling operation, so that they are able to dip into screw recesses. Thus, a torque limitation unit would be active in the percussion drilling operation.

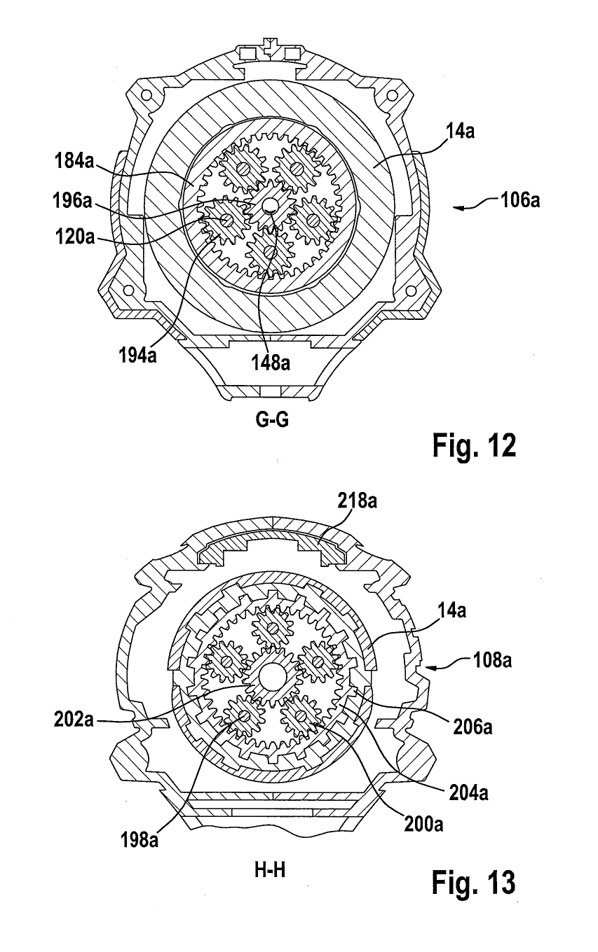

FIG. 12 shows a sectional area G of second planetary transmission stage 106a. At least during a drilling operation, internal geared wheel 184a of second planetary transmission stage 106a is supported, protected from a complete revolution, in hand-held tool housing 14a. Planet pinions 194a of second planetary transmission stage 106a mesh with internal geared wheel 184a and a sun wheel 196a of second planetary transmission stage 106a.

FIG. 13 shows a sectional area H of third planetary transmission stage 108a. Sun wheel 196a of second planetary transmission stage 106a is connected torsionally fixed to a planet carrier 198a of third planetary transmission stage 108a. Planet pinions 200a of third planetary transmission stage 108a mesh with a sun wheel 202a and an internal geared wheel 204a of third planetary transmission stage 108a. Internal geared wheel 204a of third planetary transmission stage 108a has a gearing 206a which connects internal geared wheel 204a of third planetary transmission stage 108a torsionally fixed to hand-held tool housing 14a, in a first transmission ratio.

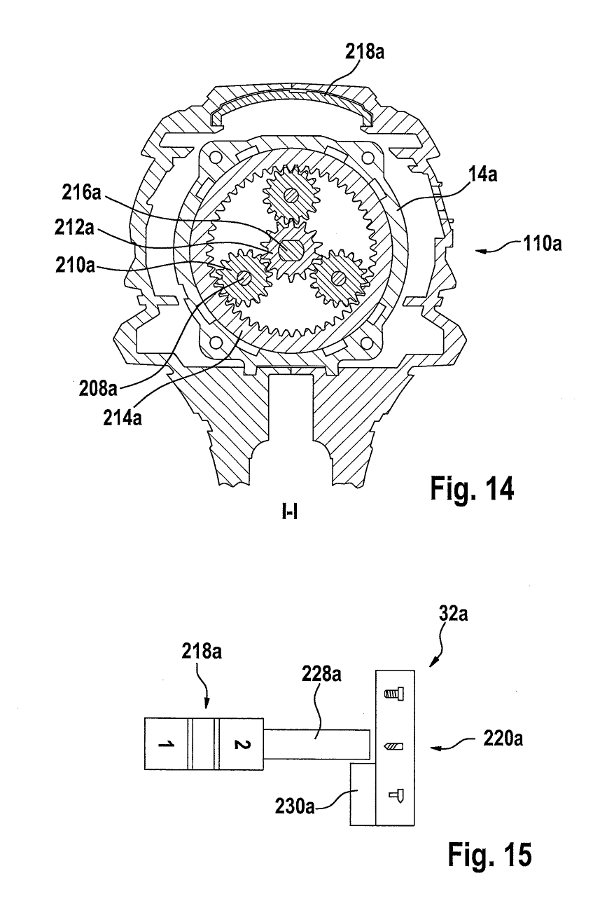

FIG. 14 shows a sectional area I of third planetary transmission stage 108a. Sun wheel 202a of third planetary transmission stage 108a is connected torsionally fixed to a planet carrier 208a of fourth planetary transmission stage 110a. Planet pinions 210a of fourth planetary transmission stage 110a mesh with a sun wheel 212a and an internal geared wheel 214a of fourth planetary transmission stage 110a. Internal geared wheel 214a is connected torsionally fixed to hand-held tool housing 14a. Sun wheel 212a of fourth planetary transmission stage 110a is connected torsionally fixed to a rotor 216a of drive unit 30a.

Internal geared wheel 204a of third planetary transmission stage 108a is supported displaceably in the axial direction, as shown in FIG. 2. In the first transmission ratio, internal geared wheel 204a of third planetary transmission stage 108a is connected torsionally fixed to hand-held tool housing 14a. In the second transmission, internal geared wheel 204a of third planetary transmission stage 108a is connected displaceably to planet carrier 208a of fourth planetary transmission stage 110a, and supported rotatably with respect to hand-held tool housing 14a. Consequently, there comes about a step-down ratio of the first transmission between rotor 216a of drive unit 30a and planet carrier 198a of third planetary transmission stage 108a which is greater than a step-down ratio of the second transmission.

Operating device 32a has a first operating element 218a and a second operating element 220a. First operating element 218a is situated on the side of hand-held tool housing 14a that faces away from handle 18a. It is supported movably parallel to the axial direction of planetary transmission 28a. First operating element 218a is connected via adjusting device 222a of operating device 32a to internal geared wheel 204a of third planetary transmission stage 108a in the axial direction. Internal geared wheel 204a of third planetary transmission stage 108a has a groove 224a in which adjusting device 222a engages. Thus, internal geared wheel 204a of third planetary transmission stage 108a is connected to adjusting means 222a in the axial direction, axially rotatable with respect to adjusting means 222a. Adjusting device 222a is developed to be springy, whereby the transmission from a rotary position of internal geared wheel 204a of third planetary transmission stage 108a is able to be adjusted independently. When first operating element 218a is pushed in the direction of tool chuck 36a, this sets the first transmission. When second operating element 220a is pushed away from tool chuck 36a, this sets the second transmission.

Second operating element 220a is situated on the side of hand-held tool housing 14a that faces away from handle 18a. Second operating element 220a is situated displaceable about an axis which is aligned parallel to the axial direction of planetary transmission 28a. Second operating element 220a is connected torsionally fixed to control element 134a of hand-held tool device 12a. Using second operating element 220a, one is able to set the screw mode, the drilling mode and the percussion drilling mode. When second operating element 220a is pushed to the left, as seen in striking direction 54a, this sets the percussion drilling mode. When second operating element 220a is pushed to the right, as seen in striking direction 54a, this sets the screw mode. When second operating element 220a is pushed to the middle, as seen in striking direction 54a, this sets the drilling mode.

FIG. 15 schematically shows an example protective device 226a of hand-held tool device 12a, which prevents an operation in the first transmission in the percussion drilling operation. In FIG. 15, the first transmission and the drilling mode are set. Protective device 226a is partially developed as one piece with operating device 32a. First operating element 218a has first blocking device 228a of protective device 226a connected to it in an attached form. Second operating element 220a has second blocking device 230a of protective device 226a connected to it in an attached form. Blocking devices 228a are each developed tongue-shaped. First blocking device 228a extends in the direction of second operating element 220a. Second blocking device 230a extends in the direction of first operating element 218a. Protective device 226a prevents switching over into the percussion drilling operation when the first transmission is set. Protective device 226a prevents switching over into the first transmission when the percussion drilling operation is set.

In the example embodiment, drive unit 30a is developed as an electric motor. Drive unit 30a has a maximum torque which causes a maximum tool torque in the first transmission of more than 15 Nm, and in the second transmission of less than 15 Nm. The maximum tool torque in the first transmission amounts to 30 Nm. The maximum tool torque in the second transmission amounts to 10 Nm. In this context, the tool torque should be determined according to Standard DIN EN 60745.

Striking mechanism switching spring 148a of hand-held tool device 12a, in the case of a percussion drilling operation, opens striking mechanism shut-off clutch 142a when the operator removes the insertable tool from the workpiece. Striking mechanism switching spring 148a is situated coaxially to planetary transmission stages 104a, 106a, 108a, 110a of planetary transmission 28a. Second planetary transmission stage 106a and third planetary transmission stage 108a enclose striking mechanism switching spring 148a in each case in at least one plane, which is aligned perpendicular to the axial direction of planetary transmission 28a. Second planetary transmission stage 106a and third planetary transmission stage 108a are each situated functionally between at least two additional planetary transmission stages 104a, 106a, 108a, 110a of planetary transmission 28a. Planet carrier 120a of second planetary transmission stage 106a supports striking mechanism switching spring 148a on the side facing away from tool chuck 36a.

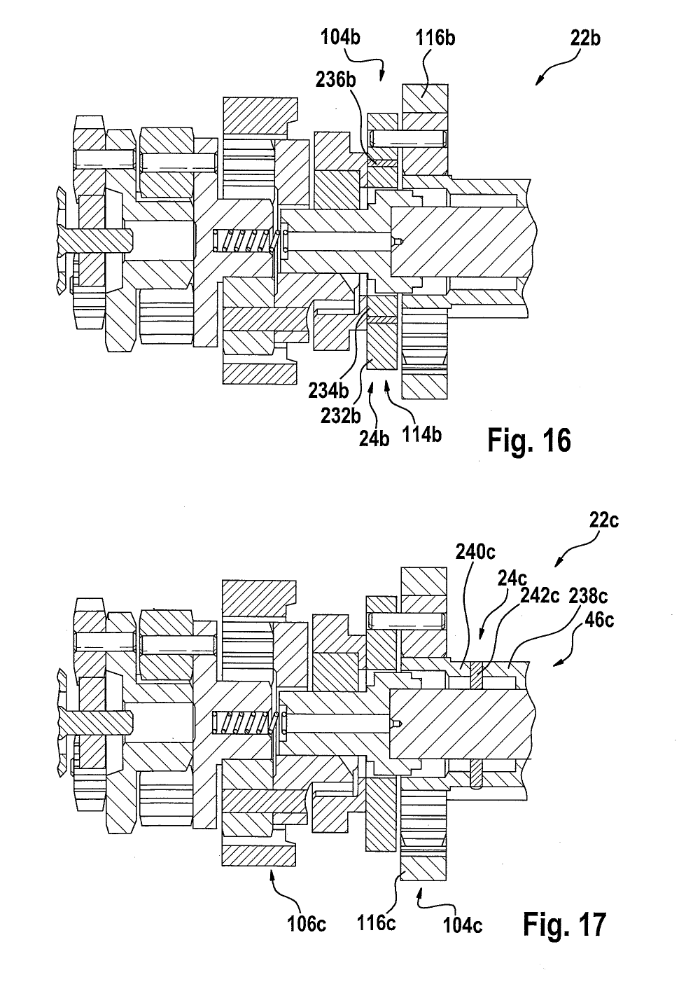

FIGS. 16 through 19 show additional exemplary embodiments of the present invention. The following descriptions and the figures are limited generally to the differences between the exemplary embodiments. Regarding components that are designated in the same way, particularly regarding components having identical reference numerals, it is fundamentally possible to refer also to the figures and/or the description of the other exemplary embodiments, especially of FIGS. 1 through 15. In order to distinguish the exemplary embodiments, the letter a is added after the reference numerals of the exemplary embodiment in FIGS. 1 through 15. In the exemplary embodiments of FIGS. 16 through 19, the letter a is replaced by the letter b or by the letters b through e.

FIG. 16 shows schematically an additional, alternative exemplary embodiment of a first striking mechanism shut-off device 24b. A planet carrier 114b of a first planetary transmission stage 104b is developed in two parts. A first part 232b of the planet carrier 114b guides planet pinions 112b of first planetary transmission stage stage 104b. A second part 234b of planet carrier 114b is torsionally coupled to a second planetary transmission stage 106b. A first striking mechanism shut-off device 24b of a striking mechanism 22b has a freewheel 236b which connects first part 232b and second part 234b of planet carrier 114b in response to a right hand drilling rotation direction and separates them in response to a left handed drilling rotation direction. An internal geared wheel 116b of first planetary transmission stage 104b is permanently connected to an hand-held tool housing, torsionally fixed.

FIG. 17 shows schematically a next exemplary embodiment of a first striking mechanism shut-off device 24c. A striking mechanism spindle 46c of a striking mechanism 22c is developed in two parts. A first part 238c of striking mechanism spindle 46c is connected to a striking mechanism drive device. A second part 240c of striking mechanism spindle 46c is connected to a second planetary transmission stage 106c. First striking mechanism shut-off device 24c has a freewheel 242c which connects first part 238c and second part 240c of striking mechanism spindle 46c torsionally fixed, in response to a right hand drilling rotation direction and separates them in response to a left handed drilling rotation direction. An internal geared wheel 116c of first planetary transmission stage 104c is permanently connected, torsionally fixed, to an hand-held tool housing.

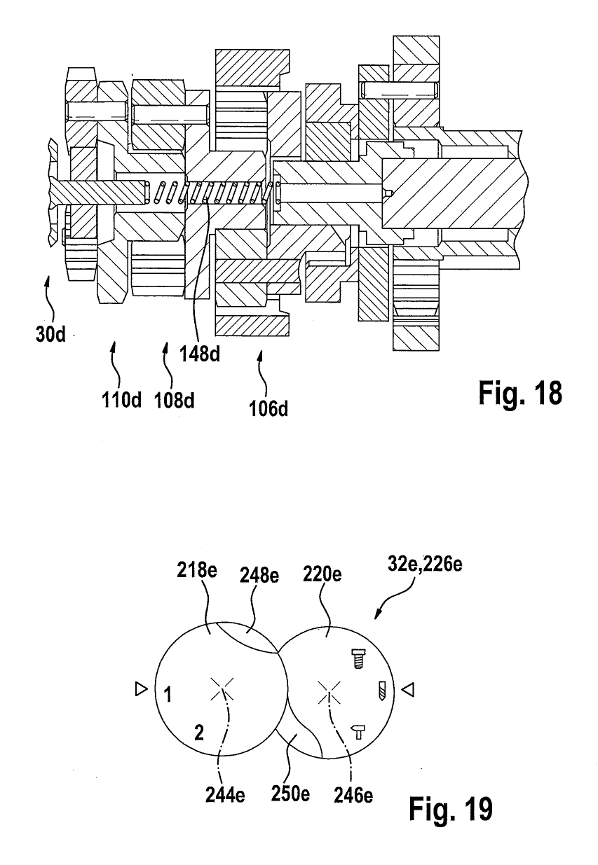

FIG. 18 shows a further exemplary embodiment of a striking mechanism switching spring 148d. A second planetary transmission stage 106d supports striking mechanism switching spring 148d on the side facing the tool chuck. A drive unit 30d supports striking mechanism switching spring 148d on the side facing away from the tool chuck. Second planetary transmission stage 106d, a third planetary transmission stage 108d and a fourth planetary transmission stage 110d enclose the striking mechanism switching spring 148d in each case in at least one plane, which is aligned perpendicular to an axial direction of planetary transmission stages 106d, 108d, 110d. Drive unit 30d is connected torsionally fixed to a part of planetary transmission stage 110d.

FIG. 19 shows an alternative exemplary embodiment of operating device 32e and a protective device 226e. Operating device 32e has a first operating element 218e and a second operating element 220e. Operating elements 218e, 220e are supported in a pivotable manner about rotational axes 244e, 246e. Operating elements 218e, 220e have a disk-shaped basic form. First operating element 218e, which is not shown in greater detail, is connected to a planetary transmission via a conventional mechanism. A first transmission and a second transmission are able to be set using first operating element 218e. Second operating element 220e, which is not shown in greater detail, is connected to a control element via a conventional mechanism. Using second operating element 220e, one is able to set the screw mode, the drilling mode and the percussion drilling mode. Moreover, one might be able to set a chisel mode.

Protective device 226e has a freewheeling region 248e bordered by first operating element 218e. Protective device 226e has a freewheeling region 250e bordered by second operating element 250e. Freewheeling region 248e of first operating element 218e enables the setting of the screw mode, the drilling mode and the percussion drilling operation when a second transmission has been set. Freewheeling region 250e of second operating element 220e enables the setting of the screw mode and the drilling mode when a second transmission has been set.

In the percussion drilling operation, protective device 226e prevents setting the first transmission. When the first transmission has been set, protective device 226e prevents setting the percussion drilling operation.

What is claimed is:

1. An hand-held tool device including at least one operating device via which at least one first transmission ratio, a second transmission ratio, and a percussion drilling mode are able to be set, the hand-held tool device further including a protective device which is configured to prevent an operation in the first transmission ratio when the hand-held tool device is in the percussion drilling mode.

2. The hand-held tool device as recited in claim 1, wherein the protective device is configured to prevent switching over into the percussion drilling mode when the first transmission ratio is set.

3. The hand-held tool device as recited in claim 1, wherein the protective device is configured to prevent switching over into the first transmission ratio when the percussion drilling mode is set.

4. The hand-held tool device as recited in claim 1, in the first transmission ratio, a maximum tool torque is more than 15 Nm.

5. The hand-held tool device as recited in claim 1, in the second transmission ratio, a maximum tool torque is less than 15 Nm.

6. The hand-held tool device as recited in claim 1, wherein the operating device has a first operating element via which the first transmission ratio and the second transmission ratio are able to be set.

7. The hand-held tool device as recited in claim 6, wherein the operating device has a second operating element via which at least the percussion drilling mode is able to be set.

8. The hand-held tool device as recited in claim 1, wherein the protective device is at least partially one piece with the operating device.

9. The hand-held tool device as recited in claim 7, further comprising:
a torque limitation unit that is able to be set, which is configured to limit a maximum tool torque in a screw mode of the hand-held tool device.

10. The hand-held tool device as recited in claim 9, wherein the operating device is configured to deactivate the torque limitation unit in a drilling mode.

11. A hand-held tool, comprising a hand-held tool device including at least one operating device via which at least one first transmission ratio, a second transmission ratio, and a percussion drilling mode are able to be set, the hand-held tool device further including a protective device which is configured to prevent an operation in the first transmission ratio when the hand-held tool device is in the percussion drilling mode.
